(19) United States
(12) Patent Application Publication
(10) Pub. No.: US 2016/0350033 A1
(43) Pub. Date: Dec. 1, 2016

(54) METHOD FOR PROCESSING A PRINT JOB IN A COMPUTER-AIDED PREPRESS STAGE

(71) Applicant: MUELLER MARTINI HOLDING AG, Hergiswil (CH)

(72) Inventors: Stefan Bulgheroni, Wikon (CH); Daniel Lutziger, Birmenstorf (CH)

(73) Assignee: MUELLER MARTINI HOLDING AG, Hergiswil (CH)

(21) Appl. No.: 15/167,124

(22) Filed: May 27, 2016

(30) Foreign Application Priority Data
May 28, 2015 (CH) 00775/15

(51) Int. Cl. G06F 3/12; G06K 15/02

(52) U.S. Cl. CPC G06F 3/1208; G06F 3/1215; G06F 3/1248; G06F 3/124; G06K 15/1836

(57) ABSTRACT

A method for processing a print job in a computer-aided prepress stage for which the print job comprises a number of same printed products (B), respectively containing several different pages (A). At least one of the printed products (B) comprises at least one page (A) with at least one additional information element (C) that differs from at least one additional information element (C) of at least one otherwise identical page (A) of a different printed product (B) and for which the pages (A) of the printed product (B) and the additional information elements (C) are transmitted to a computer used in the prepress stage. Pages (A) which appear multiple times in the printed products (B) are imposed only once and only the different pages (A) of a print job are ripped. A digital work list (E) generated from the print job is made available jointly with the ripped pages (A) to a digital printing press used to print the products (B) of the print job.

### CROSS-REFERENCE TO RELATED APPLICATION

This application claims priority to Swiss Application No. 00775/15, filed May 28, 2015, the disclosure of which is incorporated herein by reference in its entirety.

### BACKGROUND OF THE INVENTION

The invention relates to a method for processing a print job in a computer-aided prepress stage for which the print job involves a number of identical printed products with respectively several different pages, for which at least one of the printed products of the print job contains at least one page with at least one additional information element that differs from at least one additional information element of at least one otherwise identical page of a different printed product of the print job, and for which the pages of the printed products for the processing of the print job are transmitted in a computer-readable page-description language and the additional information elements of the print job are transmitted in a computer-readable form to a computer used in the prepress stage.

With the traditional offset printing, the print material containing all pages of a later printed product are printed sequentially and indirectly, meaning the printing ink is transferred in a printing mechanism with the aid of several printing cylinders, starting from a plate cylinder via a rubber-blanked cylinder to the print material. To apply different colors, several print mechanisms are arranged one behind the other. In the process, a great number of a first signature or of a first page is generated which have respectively the same format and the same content. The printing press is then retooled and again a great number of a different signature or of a different page is produced which also have the same format and the same content respectively among each other. Depending on the product to be produced, additional signatures or pages are generated for which the printing press is again retooled. The signatures and/or pages which are stored intermediately in separate stacks are collated during a following processing step in the sequence intended for the printed product, if applicable are folded to the required format, and are subsequently trimmed and bound. With this method, which is particularly suitable for large editions, a plurality of the same printed products are generated which in principal correspond to the pre-produced number of identical signatures and/or pages.

The print material for the digital printing that is based on digital data, on the other hand, can be sequentially printed directly with different formats and/or contents, meaning without the transfer of printing ink with the aid of print cylinders. A retooling in-between is not required. The printing can furthermore take place in the page sequence required for the printed product to be produced in each case. A printing process of this type is therefore also referred to as sequential printing. Following the printing, the signatures and/or the pages if applicable are also folded to the required format, are collated, trimmed and bound. This method has proven to be particularly economic for producing small editions up to a single product.

In the course of developing the digital printing method, considerable changes were made not only to the actual printing method and the subsequent post processing of the intermediate products, but also to the upstream processes of the printing operation, the so-called prepress stage. These days, the data required for producing a printed product are either already available in a computer-readable page-description language, for example as a PDF file (transportable document format), or they have been converted ahead of time into such a page-description language. In the process, digital pages and/or digital signatures containing all information necessary for the printing and the subsequent post processing are created in a computer-aided prepress stage from the pages of the original draft to be printed, which contain at least one of the elements of text, graphic and image. This combining of several pages into at least one signature, which generally takes place at a single computer work station, and the arrangement of these pages on the signature such that they follow each other in the intended sequence after the subsequent printing, folding and collating, is referred to as imposition. As a result, the electronic documents are present as so-called imposed pages and/or as an imposed file, for example in PDF format. Following this, each individual imposed page is converted in a raster image processor (RIP) to a machine-specific data format, readable by the digital printing press (e.g. the two-dimensional raster graphics format “windows bitmap”). This conversion process is referred to as “ripping” or also as “rastering.” The device-specific data format generated in this way, or at least one file containing this data format, finally triggers the respective printing of the pages and/or the signatures on the print material (see Handbook of Print Media, Springer Publishing House, 2000, ISBN 3-540-66941-8, pp 522ff, 561ff, 702ff).

If a current print job requires the use of a digital printing press for printing with a method according to the prior art, for example the printing of ten printed products in the form of books with respectively one hundred twenty identical pages which, however, differ each by at least one additional information element affixed to a specific page, representing an additional value for the buyer of the book, then these one hundred twenty pages initially exist in a computer-readable page description language (e.g. the PDF format). A corresponding additional information element, e.g. a barcode, a text, an advertisement or a graphic, is furthermore provided in computer-readable form. With the aid of such an additional information element, which can be evaluated via the Internet, the buyer can obtain access to additional contents, videos, courses and the like, wherein it makes sense if this access is available only once for each book.

A processed file, also called an expanded file, is generated from the one hundred twenty pages and the information elements, which file contains all pages of each book and the information elements respectively affixed to the corresponding pages. The processed file therefore holds the content of ten books x one hundred twenty pages, meaning one thousand two hundred pages.

In the following, the one thousand two hundred pages of the processed file are imposed corresponding to the intended format for the books and the connected folding pattern. When using a so-called F24 folding pattern, meaning respectively twenty-four pages of each signature are combined (respectively with a front and back page) of each book to be produced, resulting in an imposed file with fifty signatures, that is to say with one hundred imposed pages.

The imposed file is ripped during a further method step, meaning the one hundred imposed pages are converted to the data format required for the digital printing press, resulting in multiple copies of many contents of the imposed file. Since each individual page is converted during the ripping to the data format of the digital printing press, the same calculations must be realized multiple times for this prior art method. Depending on the size of the print job and each individual book in the print job, depending on the type and scope of the elements contained on the pages (texts, graphics, images), and depending on the computer used for processing the print job in the prepress stage, however, the ripping can be very time-consuming. The time required for this operation can thus range from several seconds to approximately one hour. The actual digital printing of the fifty signatures can take place only after at least a portion of the imposed file has been ripped, wherein subsequently five separate signatures are respectively combined to form a book block and the ten resulting books are bound.

With digital printing presses using continuous webs and in particular digital printing systems with inline post-processing of the signatures, meaning with machine systems where the signatures produced with the digital printing press are processed directly into printed products, as is the case with the digital book production line “SigmaLine” of the applicant, the ripping thus can prove to be a limiting factor for an economic printing and/or production of books.

### SUMMARY OF THE INVENTION

Thus it is an object of the present invention to create a method for processing a print job in a computer-aided prepress stage in which the partial process of the ripping and thus the digital printing and/or the total book production process can be shortened.

The above and other objects are achieved by a method according to the invention, wherein, in one embodiment, there is provided a method for processing a print job in a computer-aided prepress stage, for which the print job comprises a number of the same printed products (B) with respectively several different pages (A), for which at least one of the printed products (B) of the print job comprises at least one page (A) with at least one additional information element (C) that differs from at least one other additional information element (C) of at least one otherwise identical page (A) of a different printed product (B) of the print job, for which the pages (A) of the printed products (B) of the print job are transmitted in a computer-readable page description language and the additional information elements (C) of the print job are transmitted in a computer-readable form to a computer used in the prepress stage for processing the print job, the method comprising: imposing only the pages (A) of one printed product (B) of the print job via a computer, thereby creating imposed pages (D); copying at least one of the imposed pages (D), intended for accommodating the at least one additional information element (C), such that following the copying, the precise number of imposed and copied pages (D) exist which are required for accommodating the additional information elements (C) of the print job; inserting the additional information elements (C) into the at least one imposed page intended for accommodating it and into the at least one copied page (D); creating a digital work list (E) based on the print job which comprises a print sequence for the imposed and copied pages (D); ripping the at least one imposed and the at least one copied page (D) with therein inserted additional information elements (C), as well as the additional imposed pages (D) that do not contain additional information elements; and making available to a digital printing press the ripped pages and the digital work list (E) for printing the printed products (B) of the print job.

According to the invention, imposed pages are generated in that only the pages of a single printed product of the print job are imposed with the aid of the computer. The imposed pages and thus the pages combined in at least one signature are arranged such that the pages follow each other in the intended sequence for the final printed product, meaning following the printing, the subsequent folding and collating of the signatures.

Thereafter, at least one of the imposed pages intended for accommodating the at least one additional information element is copied so that precisely the number of imposed and copied pages which are needed for accommodating the additional information elements of the print job are present after the copying. Depending on the print job, meaning after knowing how many and which pages of the printed products are to contain at least one additional information element, all imposed pages intended for accommodating at least one additional information element are copied at least once and maximally corresponding to the number of the printed products of the print job. The additional information elements are then inserted into the at least one imposed and into the at least one copied page intended therefore. In addition, a digital work list is generated from the print job, which contains a printing sequence of the imposed and the copied pages.

The at least one imposed and the at least one copied page with therein inserted additional information elements, as well as the further imposed pages without additional information elements are then ripped, meaning they are converted to a data format readable by the digital printing press.

The ripped pages and the digital work list are finally made available to a digital printing press which prints out the products according to the print job.

With the inventive method, pages appearing multiple times in a print job are advantageously processed only once, meaning imposed and ripped. In contrast to the prior art, relatively few pages of a print job must therefore be processed with this method. In particular the partial process of ripping and thus also the digital printing process and/or the total book production process can thus be shortened considerably. In addition, this method can be realized quite advantageously without having to make changes to the hardware and software required for the ripping and can thus be integrated without additional costs into existing sequences for processing a print job in a computer-aided prepress stage.

According to one embodiment of the inventive method, the pages of the printed products and the additional information elements of the print job are transmitted to the computer either in separate input files or in a joint input file, depending on the specific application case. When using separate input files, respectively one or also several input files can be used for the pages of the printed product and for the additional information elements.

According to a different embodiment of the inventive method, a PDF format is used as the computer-readable page description language. As a result, these data files can advantageously be imaged in a standard data format.

According to yet another embodiment of the inventive method, the additional information elements are advantageously transmitted from at least one electronic database and/or from at least one file to the computer used during the prepress stage, wherein the selection between these two alternatives is based on the specific application case.

A different embodiment according to the inventive method provides that the digital work list for a print job with a number of additional, identical printed products, respectively containing at least one identical additional information element such as can be found on at least one of the identical printed products, is supplemented by the same number of these additional, identical printed products. In that case, the digital work list contains in addition to the printing sequence of the imposed and the copied pages, additionally the number of same printed products with identical additional information elements. In contrast to the prior art, even print jobs which contain a number of identical printed products with respectively different information elements and also an optional number of equally identical printed products with at least one information element that is identical to the same printed products can thus be realized advantageously with noticeably less expenditure.

### BRIEF DESCRIPTION OF THE DRAWINGS

The invention is described further in the following with the aid of an exemplary embodiment, showing in:

FIG. 1 shows a first input file containing the pages of the current print job;

FIG. 2 shows a second input file with the different information elements of the current print job;

FIG. 3 shows a third input file with imposed pages of the current print job;

FIG. 4 show a modified third file with the imposed and copied pages, as well as the information elements inserted therein;

FIG. 5 shows a digital work list with assignment of the information from the modified third file to the respective printed products to be produced;

FIG. 6 shows a sequence for processing the printed products to be produced based on the work list.

### DETAILED DESCRIPTION

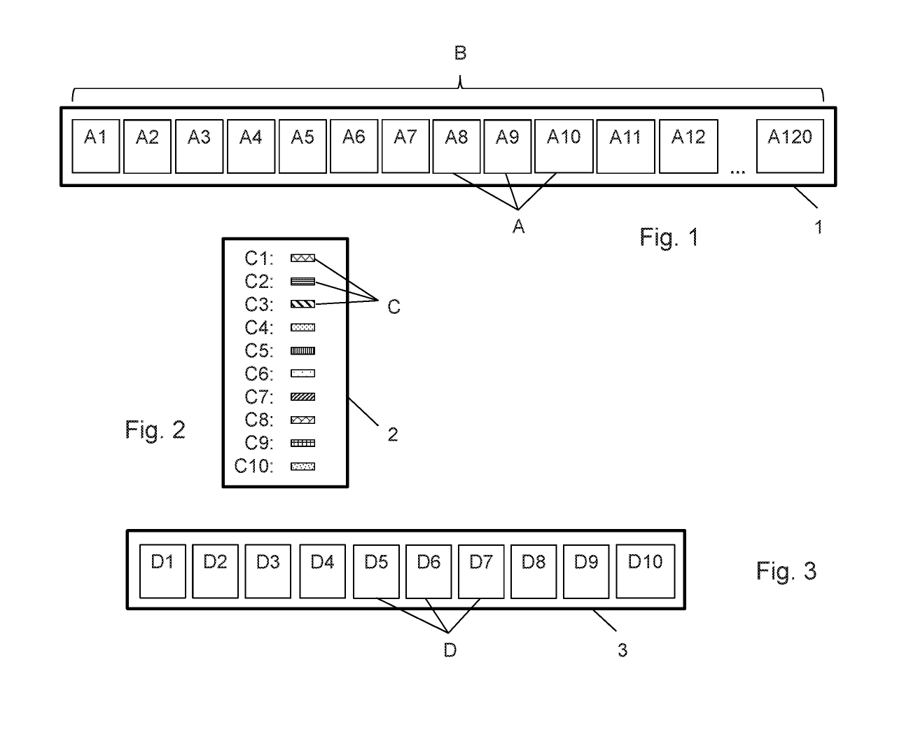

The invention is explained by way of an example that is analogous to the example provided in the description of the prior art. According to this example, ten printed products B in the form of books, containing respectively one hundred twenty identical pages A, are to be digitally printed according to a print job (FIG. 1). Each printed product B of this print job is to contain a page A with one additional information element C (FIG. 2) which differs from the information elements C of the other printed products B of the print job. The additional information element C in that case can be affixed to the same page A of the printed product B or also to different pages A, wherein respectively at least two additional information elements C, however, are provided on the same page of a different printed product B. Alternatively, only some printed products B, but at least two printed products B of the print job, can comprise such a page A with one additional information element C. In the same way, several pages A of a printed product B can also be provided with one additional information element C or some pages A can contain more than one information element C.

According to the above-described example of a print job for ten printed products B1 . . . B10, a computer used in the prepress stage for processing the print job is provided with one hundred twenty pages A1 . . . A120 (FIG. 1) in a computer-readable page description language, for example in PDF format, as well as with ten different information elements C1 . . . C10 (FIG. 2) in a computer-readable form, wherein the information elements C1 . . . C10 are to be affixed respectively to the same page of the printed products B1 . . . B10. The one hundred twenty pages A1 . . . A120 as well as the ten information elements C1 . . . C10 can then be stored respectively at least in a separate input file 1, 2 (FIG. 1, FIG. 2) or also in a joint input file.

The one hundred twenty pages A1 . . . A120 are imposed with the aid of the computer used during the prepress stage, corresponding to the intended format for the printed products B1 . . . B10 and the therewith associated folding pattern. If a F24 folding pattern is furthermore used, a third file 3 is generated with five signatures, meaning with ten imposed pages D1 . . . D10 (FIG. 3).

According to the available print job, only the imposed page D1 is therefore copied nine times, which page is intended for accommodating differing contents, meaning for accommodating one of the information elements C1 . . . C10. The remaining pages D2 . . . D10 of all ten printed products B1 . . . B10 of the print job are identical. Following the copying, the third file 3′ thus contains the nineteen pages listed in the following:
the one imposed page D1 used for the copying which is henceforth called D1.1;
nine copies of the imposed page D1.1 given the references D1.2 . . . D1.10;
the remaining nine imposed pages D2 . . . D10.

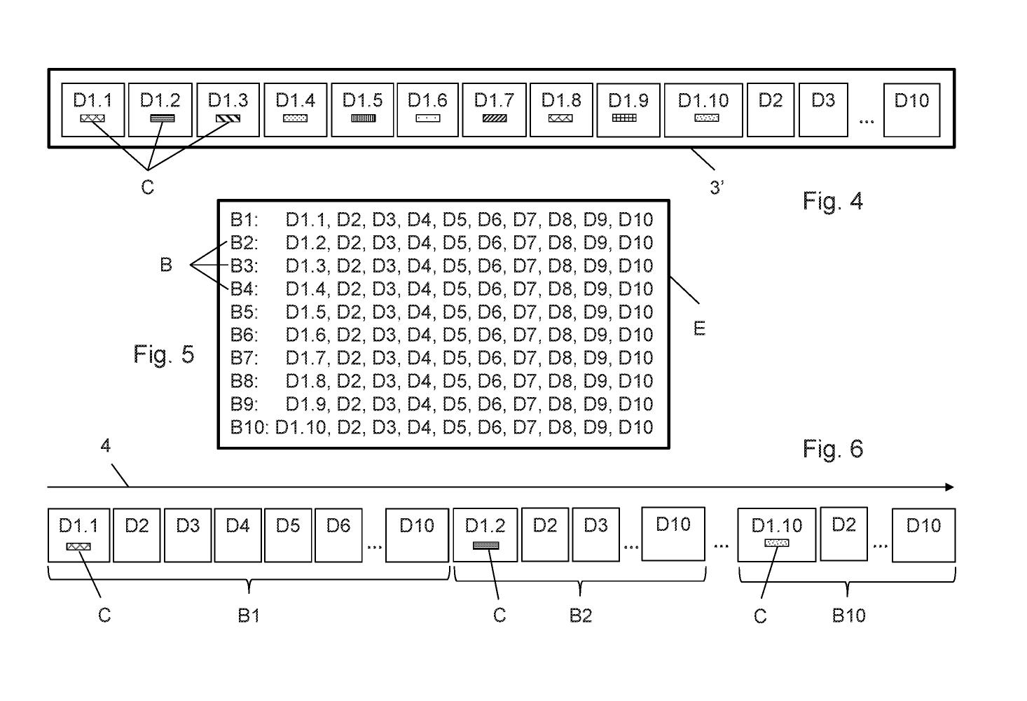

The respectively required information element C1 . . . C10 is then affixed (FIG. 4) to the copied pages D1.2 . . . D1.10 and the imposed page D1.1, functioning as copy template. The third file 3′ and/or its nineteen pages D1.1 . . . D1.10 and D2 . . . D10, modified in this way, are then ripped.

Essentially parallel to the imposition or the ripping, but no later than following the ripping, a digital work list E is created for the print job (FIG. 5) which contains the specified printing sequence for the pages A of each printed product B1 . . . B10 of the print job. The ripped nineteen pages and the digital work list E are subsequently made available to a digital printing press which processes the print job, meaning the pages A1 . . . A120 of the printed products B1 . . . B10. The printing sequence for pages D1.1 . . . D10, D1.2 . . . D10 up to D1.10 . . . D10 of the ten printed products B1 . . . B10 of the current print job which pages must be printed successively is shown with the arrow 4 in FIG. 6. Of course, the printing can also be carried out in the reverse order or in a different sequence.

Depending on the print job, this can of course result in a different number of imposed pages to be copied and thus pages of the third file 3′ intended for the ripping. In general, however, it can be said that all imposed pages D intended for accommodating at least one additional information element, are copied at least once and maximally corresponding to the number of printed products B of the print job, and are ripped following the inserting of the corresponding information elements C.

In contrast to the initially described method according to the prior art, for which one hundred pages must be ripped, only nineteen pages must be ripped with the inventive method described in the example. The required time for processing the partial process of ripping can thus be advantageously lowed to approximately 20% with this method.

For example, if a print job exists for which in addition to a first number of the same printed products B with respectively at least one different additional information element C, a second number are to be printed of the same printed products B′ with an additional identification element C, which is identical to at least one of the additional information elements C of the same printed products B, the digital work list E is only expanded by the number of these additional, same printed products B′. In this way, even print jobs of this type can be realized with relatively little expenditure.

It will be understood that the above description of the present invention is susceptible to various modifications, changes and adaptations, and that the same are intended to be comprehended within the meaning and range of equivalents of the appended claims.

What is claimed is:

1. A method for processing a print job in a computer-aided prepress stage, for which the print job comprises a number of the same printed products (B) with respectively several different pages (A), for which at least one of the printed products (B) of the print job comprises at least one page (A) with at least one additional information element (C) that differs from at least one other additional information element (C) of at least one otherwise identical page (A) of a different printed product (B) of the print job, for which the pages (A) of the printed products (B) of the print job are transmitted in a computer-readable page description language and the additional information elements (C) of the print job are transmitted in a computer-readable form to a computer used in the prepress stage for processing the print job, the method comprising:
imposing only the pages (A) of one printed product (B) of the print job via a computer, thereby creating imposed pages (D);
copying at least one of the imposed pages (D), intended for accommodating the at least one additional information element (C), such that following the copying, the precise number of imposed and copied pages (D) exist which are required for accommodating the additional information elements (C) of the print job;
inserting the additional information elements (C) into the at least one imposed page intended for accommodating it and into the at least one copied page (D);
creating a digital work list (E) based on the print job which comprises a print sequence for the imposed and copied pages (D);
ripping the at least one imposed and the at least one copied page (D) with the therein inserted additional information elements (C), as well as the additional imposed pages (D) that do not contain additional information elements; and
making available to a digital printing press the ripped pages and the digital work list (E) for printing the printed products (B) of the print job.

2. The method according to claim 1, further including transmitting to the computer used in the prepress stage for processing the print job the pages (A) of the printed products (B) and the additional information elements (C) of the print job in separate input files or in a joint input file.

3. The method according to claim 1, further including using a PDF format for the computer-readable page description language.

4. The method according to claim 1, further including transmitting the additional information elements (C) from at least one electronic database and/or at least one file to the computer used in the prepress stage.

5. The method according to claim 1, wherein a print job comprises a number of additional, same printed products (B′), which respectively are provided with at least one identical additional information element (C) such as at least one of the same printed products (B), the method further includes supplementing the digital work list (E) by the number of said additional, same printed products (B′).
